(19) United States
(12) Patent Application Publication
(10) Pub. No.: US 2015/0120361 A1
(43) Pub. Date: Apr. 30, 2015

(54) INFORMATION PROCESSING DEVICE

(71) Applicant: NEC Corporation, Minato-kuTokyo (JP)

(72) Inventor: Katsuichi Tachibana, Tokyo (JP)

(73) Assignee: NEC Corporation, Tokyo (JP)

(21) Appl. No.: 14/388,498

(22) PCT Filed: Mar. 21, 2013
(86) PCT No.: PCT/JP2013/001921

§ 371 Date: Sep. 26, 2014

(30) Foreign Application Priority Data
Mar. 30, 2012 (JP) 2012-079715

(51) Int. Cl. G06Q 10/10

(52) U.S. Cl. CPC G06Q 10/1095
USPC 705/7.19

(57) ABSTRACT

An information processing device includes: a first communication means for receiving request information sent from a user terminal device operated by a user to request for the user to use a service provided by a provider, and a second communication means for sending, to a provider-side terminal device operated by the provider, order information generated based on the request information to place an order with the provider for providing the service to the user, and receiving, from the provider-side terminal device, work information indicating a schedule for the provider to provide the service to the user, wherein the first communication means sends the work information to the user terminal device to receive answer information to the work information from the user terminal device and, according to the situation of receiving the answer information, sends warning information to the user terminal device to urge the sending of the answer information.

### TECHNICAL FIELD

The present invention relates to information processing devices and, more particularly, to an information processing device mediating between user terminal devices and terminal devices at the side of a provider who provides a service.

### BACKGROUND ART

There are widespread systems which mediate between user terminal devices owned by a user and provider-side terminal devices owned by a provider so as to provide the user with a service offered by the provider. For example, the following patent document 1 proposes such a technique for an intermediate agent dealing with installation of electric communication equipment to receive an installation request from a customer, select a subcontractor carrying out installation of electric communication equipment, and make a request for the installation.

Patent Document 1: JP 2008-176421 A

However, as with the technique disclosed in the patent document 1, in the case of mediating between the user terminal devices and the provider-side terminal devices, for example, if the user forgets to answer to predetermined information sent from a provider-side terminal device, then there are cases where information communications are subject to interruption between the user terminal device and the provider-side terminal device.

For example, when approval of an installation work has not yet been gained from the user terminal devices even if the scheduled date for the installation work is approaching, information communications may be interrupted between the user terminal devices and the provider-side terminal devices. As a result, there is a problem that the user cannot be provided with the service as scheduled.

### SUMMARY

Hence, an exemplary object of the present invention is to provide an information processing device capable of solving the above problem that the user cannot be provided with the service as scheduled.

In order to achieve the above exemplary object, an aspect of the present invention provides an information processing device taking such a configuration as to include:

a first communication means for receiving request information sent from a user terminal device operated by a user, to request for the user to use a service provided by a provider; and

a second communication means for sending, to a provider-side terminal device operated by the provider, order information generated based on the request information to place an order with the provider for providing the service to the user, and receiving, from the provider-side terminal device, work information indicating a schedule for the provider to provide the service to the user,

wherein the first communication means sends the work information to the user terminal device to receive answer information to the work information from the user terminal device and, according to the situation of receiving the answer information, sends warning information to the user terminal device to urge the sending of the answer information.

Further, another aspect of the present invention provides an information processing method taking such a configuration as to include:

receiving request information sent from a user terminal device operated by a user, to request for the user to use a service provided by a provider;

sending, to a provider-side terminal device operated by the provider, order information generated based on the request information to place an order with the provider for providing the service to the user, and receiving, from the provider-side terminal device, work information indicating a schedule for the provider to provide the service to the user; and

sending the work information to the user terminal device to receive answer information to the work information from the user terminal device and, according to the situation of receiving the answer information, sending warning information to the user terminal device to urge the sending of the answer information.

Further, still another aspect of the present invention provides a computer program comprising instructions for causing an information processing device to realize a function,

the information processing device including:

a first communication means for receiving request information sent from a user terminal device operated by a user, to request for the user to use a service provided by a provider; and

a second communication means for sending, to a provider-side terminal device operated by the provider, order information generated based on the request information to place an order with the provider for providing the service to the user, and receiving, from the provider-side terminal device, work information indicating a schedule for the provider to provide the service to the user,

wherein the first communication means sends the work information to the user terminal device to receive answer information to the work information from the user terminal device and, according to the situation of receiving the answer information, sends warning information to the user terminal device to urge the sending of the answer information.

Being configured in the above manner, the present invention has such a beneficial effect as is capable of suppressing the interruption of information communications between a user terminal device and a provider-side terminal device.

### BRIEF DESCRIPTION OF DRAWINGS

FIG. 1 is a block diagram showing a schematic configuration of an information processing system in accordance with an exemplary embodiment of the present invention;

FIG. 2 is a block diagram showing a configuration of an information processing device in accordance with the present invention;

FIG. 3 is a block diagram showing a configuration of a user-side server device in accordance with the present invention;

FIG. 4 is a block diagram showing a configuration of a provider-side server device in accordance with the present invention;

FIG. 5 is a block diagram showing a configuration of a user terminal device in accordance with the present invention;

FIG. 6 is a block diagram showing a configuration of a provider-side terminal device in accordance with the present invention;

FIG. 7 is a sequence diagram showing an operation of sending request information of the information processing system in accordance with the present invention;

FIG. 8 is a sequence diagram showing an operation of sending work information of the information processing system in accordance with the present invention;

FIG. 9 is a flowchart showing an operation of an answer process in accordance with the present invention;

FIG. 10 is a sequence diagram showing an operation of sending answer information of the information processing system in accordance with the present invention;

FIG. 11 is a flowchart showing an operation of an answer information reception process in accordance with the present invention;

FIG. 12 is a sequence diagram showing an operation of sending progress information of the information processing system in accordance with the present invention;

FIG. 13 is a sequence diagram showing another operation of sending the progress information of the information processing system in accordance with the present invention; and

FIG. 14 is a sequence diagram showing an operation of sending completion information of the information processing system in accordance with the present invention.

### EXEMPLARY EMBODIMENT

### An Exemplary Embodiment

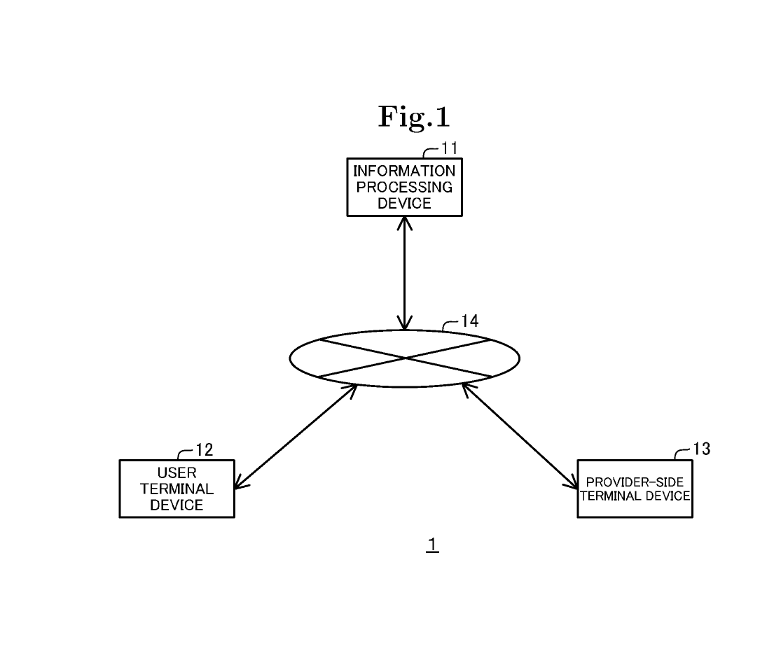

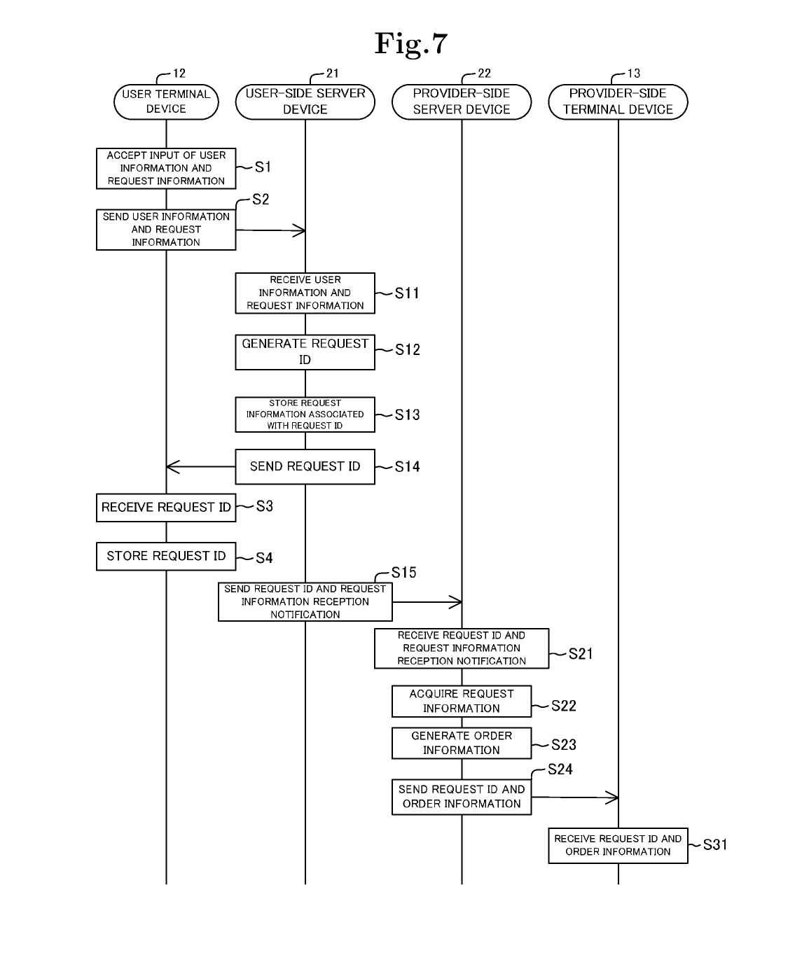

Referring to FIG. 1 through FIG. 14, an exemplary embodiment of the present invention will be explained. FIG. 1 through FIG. 6 are drawings for explaining a configuration of an information processing system 1, while FIG. 7 through FIG. 14 are drawings for explaining an operation of the information processing system 1.

[Configuration]

FIG. 1 is a block diagram showing the configuration of the information processing system 1 in accordance with the exemplary embodiment. As shown in FIG. 1, the information processing system 1 includes an information processing device 11, a user terminal device 12, a provider-side terminal device 13, and a communication network 14. Further, the user terminal device 12 and the provider-side terminal device 13 may include a plurality of such devices, respectively.

The user terminal device 12 is a personal computer, a mobile terminal device, and the like to be operated by a user. The user terminal device 12 sends, for example, request information indicating a request for arranging a (communication) line to the information processing device 11 via the communication network 14 for the user to use a service provided by a communication service provider.

The information processing device 11 is, for example, a device used by a (communication) line reseller (a mediator) who resells lines provided by a plurality of communication service providers. Line resale refers to a service by borrowing lines from communication service providers having large-scale communication line networks to sell the borrowed lines to users. On receiving the request information from the user terminal device 12, the information processing device 11 sends, to the provider-side terminal device 13 via the communication network 14, a request ID (identification information) associated with the request information, and order information generated based on the request information. The information processing device 11 mediates the information for adjusting a line installation between the user terminal device 12 and the provider-side terminal device 13, and manages the progress of the installation, until the communication service provider operating the provider-side terminal device 13 completes the arrangement of the line for the user who requests the line arrangement.

The provider-side terminal device 13 is a device operated by the communication service provider having large-scale communication line networks. On receiving a request for a line arrangement from the information processing device 11 via the communication network 14, the provider-side terminal device 13 sends information indicating a schedule for the line installation requested to arrange. Further, after the communication service provider starts the line installation, the provider-side terminal device 13 sends progress information indicating the progress of the line installation to the information processing device 11.

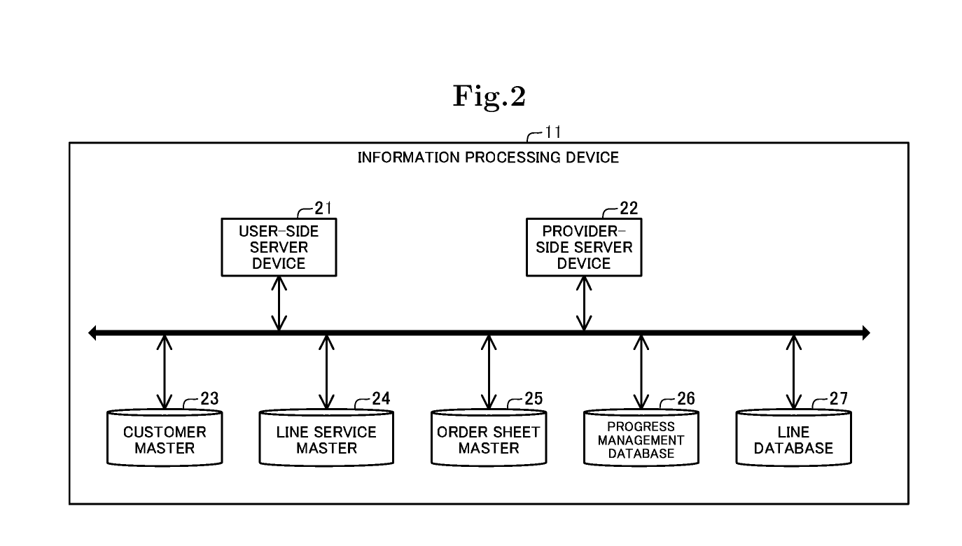

Next, referring to FIG. 2, a configuration of the information processing device 11 will be explained. FIG. 2 is a block diagram showing the configuration of the information processing device 11. As shown in FIG. 2, the information processing device 11 includes a user-side server device 21, a provider-side server device 22, a customer master 23, a line service master 24, an order sheet master 25, a progress management database 26, and a line database 27. Further, although the user-side server device 21 and the provider-side server device 22 are constructed of different devices, they may be constructed of one device or more than two devices. Further, the user-side server device 21 and the provider-side server device 22 may be connected via the communication network 14.

The customer master 23 records user (customer) information of the user operating the user terminal device 12. The customer master 23 records, as the user information, user ID (Identification), user's name, address of the user terminal device 12, and information of the person in charge of the line reseller for the user. The line service master 24 records information of the line borrowed from the communication service provider operating the provider-side terminal device 13. The line service master 24 records, for example, communication service provider ID, name of the communication service provider, service information for the service provided by the communication service provider. The order sheet master 25 records the form of order sheet (items of order sheet, for example) preset for each communication service provider. The order sheet includes information generated for using the service provided by the communication service provider. The progress management database 26 stores line information of the line designated by the user, the schedule for the line installation, and the progress of that installation. The line database 27 stores line information of the line for which the arrangement (i.e., the line installation) is completed for the user.

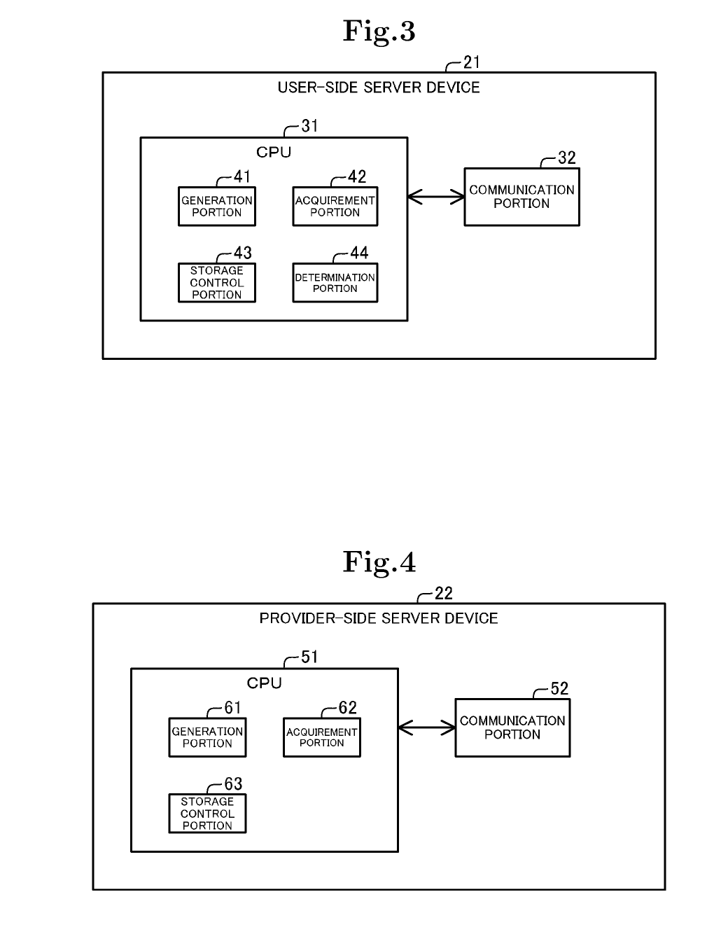

FIG. 3 is a block diagram showing a configuration of the user-side server device 21 (the first server device). The user-side server device 21 communicates with the user terminal device 12 via the communication network 14. As shown in FIG. 3, the user-side server device 21 (the first server device) includes a CPU (Central Processing Unit) 31, and a communication portion 32. The CPU 31 reads out programs to the RAM (Random Access Memory) (not shown) to carry out various processes. For example, by executing programs, the user-side server device 21 (the CPU 31) carries out the processes of a generation portion 41, an acquirement portion 42, a storage control portion 43, and a determination portion 44.

FIG. 4 is a block diagram showing a configuration of the provider-side server device 22 (the second server device). The provider-side server device 22 communicates with the provider-side terminal device 13 via the communication network 14. As shown in FIG. 14, the provider-side server device 22 (the second server device) includes a CPU 51, and a communication portion 52. The CPU 51 reads out programs to the RAM (not shown) to carry out various processes. For example, by executing programs, the provider-side server device 22 (the CPU 51) carries out the processes of a generation portion 61, an acquirement portion 62, and a storage control portion 63.

First, an explanation will be made on the process of the information processing device 11 (the user-side server device 21 and the provider-side server device 22) when the user has requested a line arrangement. The communication portion 32 (the first communication means) of the user-side server device 21 receives user information and request information sent from the user terminal device 12. The user information is information indicating the user operating the user terminal device 12. The user information includes, for example, information such as the user ID and the like. The request information is information for the user to request the communication service provider to arrange the line. The request information includes, for example, information such as communication service provider ID of the communication service provider designated by the user, name of the communication service provider, deadline, observer's name for the work, etc.

The generation portion 41 (the identification information generation means) of the user-side server device 21 generates a request ID (identification information) associated with the request information according to each piece of the request information. The storage control portion 43 (the request information storage means) of the user-side server device 21 lets the progress management database 26 store the request information associated with the generated request ID. Then, the communication portion 32 of the user-side server device 21 sends the generated request ID, and a request information reception notification indicating the reception of the request information, to the user terminal device 12 and the provider-side server device 22. By virtue of this, it is possible for the provider-side server device 22 to acquire the request information from the progress management database 26 by receiving the request ID. Further, the communication portion 32 may directly send the request information instead of the request ID to the provider-side server device 22.

The communication portion 52 (the second communication means) of the provider-side server device 22 receives the request ID and the request information reception notification sent from the user-side server device 21. Subsequently, the acquirement portion 62 (the request information acquirement means) of the provider-side server device 22 acquires the request information from the progress management database 26 based on the received request ID. The acquired request information is the request information stored due to the storage control portion 43 of the user-side server device 21. In this manner, between the user-side server device 21 and the provider-side server device 22, because the request ID is sent and received, it is possible to reduce the amount of communication.

The generation portion 61 of the provider-side server device 22 generates order information based on the acquired request information, and the items recorded in the order sheet master 25. The order information is, for example, information for ordering a line installation from the communication service provider. For example, the generation portion 61 refers to (extracts) the items recorded in the order sheet master 25 from the request information to generate the order information. The communication portion 52 of the provider-side server device 22 sends, to the provider-side terminal device 13, the request ID sent from the user-side server device 21, and the order information generated by the generation portion 61. The communication portion 52 sends, for example, the request ID and the order information to the provider-side terminal device 13 by email.

Next, an explanation will be made on the process of the information processing device 11 when the provider-side terminal device 13 has sent a reply to the order information. The communication portion 52 of the provider-side server device 22 receives the request ID and work information sent from the provider-side terminal device 13. The work information is information created by the communication service provider as the reply to the order information. The work information is information indicating the schedule for the service (the line installation, for example) provided by the communication service provider. The work information includes, for example, the scheduled date and time for the work of the line installation associated with the request ID, and worker information. The storage control portion 63 (the progress information storage means) of the provider-side server device 22 associates the work information with the request ID and lets the progress management database 26 store the same. Subsequently, the communication portion 52 of the provider-side server device 22 sends, to the user-side server device 21, the request ID, and a work information reception notification indicating the reception of the work information. By virtue of this, it is possible for the user-side server device 21 to acquire the work information from the progress management database 26 by receiving the request ID. Further, the communication portion 52 may directly send the work information instead of the request ID to the user-side server device 21.

The communication portion 32 of the user-side server device 21 receives the request ID and a work information reception notification sent from the provider-side server device 22. The acquirement portion 42 (the progress information acquirement means) of the user-side server device 21 acquires the work information from the progress management database 26 based on the received request ID. Subsequently, the generation portion 41 generates progress management information. The progress management information is, for example, information describing the scheduled date and time for the installation and the worker information (that is, the work information) according to each line. Then, the communication portion 32 of the user-side server device 21 sends the progress management information to the user terminal device 12. The communication portion 32 sends, for example, the progress management information to the user terminal device 12 by email. Further, the address for the email is stored in the customer master 23.

Next, an explanation will be made on the process of the information processing device 11 when the user terminal device 12 has sent a reply to the work information. The communication portion 32 of the user-side server device 21 receives answer information sent from the user terminal device 12. The answer information is information indicating the answer (approval or alteration) to the progress management information (the work information). The storage control portion 43 of the user-side server device 21 associates the answer information with the request ID and lets the progress management database 26 store the same. The communication portion 32 of the user-side server device 21 sends, to the provider-side server device 22, the request ID, and an answer information reception notification indicating the reception of the answer information. Further, the communication portion 32 may directly send the answer information instead of the request ID to the provider-side server device 22.

The communication portion 52 of the provider-side server device 22 receives the request ID and the answer information reception notification sent from the user-side server device 21. The acquirement portion 62 of the provider-side server device 22 acquires the answer information from the progress management database 26 based on the received request ID. The communication portion 52 of the provider-side server device 22 sends the answer information acquired by the acquirement portion 62 to the provider-side terminal device 13. If the answer information is information indicating approval of the work information (the scheduled date and time for the line installation, and the workers, for example), then the communication service provider starts to provide the service (the line installation, for example). On the other hand, if the answer information is information indicating alteration of the work information, then the communication portion 52 of the provider-side server device 22 receives, once again, new work information from the provider-side terminal device 13. Then, the information processing device 11 carries out the same process as in the case of sending a reply to the order information as described earlier.

Further, according to the situation of receiving the reply (answer information) to the work information (the progress management information) from the user terminal device 12, the user-side server device 21 can also send warning information to the user terminal device 12 for urging it to reply to the work information.

For example, the acquirement portion 42 of the user-side server device 21 acquires the scheduled date and time for the work included in the work information. Then, the determination portion 44 of the user-side server device 21 determines whether or not the user terminal device 12 has sent the reply to the work information during the (preset) period from a preset date earlier than the scheduled date and time for the work, to the scheduled date and time for the work. If the determination portion 44 determines that the user terminal device 12 has not yet sent the reply to the work information, then the communication portion 32 of the user-side server device 21 sends the warning information to the user terminal device 12. Further, the determination portion 44 may determine whether or not the preset period has passed after the communication portion 32 sends the work information. If the determination portion 44 determines that the preset period has passed after the work information is sent, then the communication portion 32 of the user-side server device 21 sends the warning information to the user terminal device 12. By virtue of this, even if the user forgets to reply to the work information, because the warning information is sent to notify and urge the user to reply (answer) to the work information, it is possible to suppress interruption of the information communications between the user terminal device 12 and the provider-side terminal device 13, and continue the communications.

Further, the information processing device 11 can also send, to the provider-side terminal device 13, warning notification information indicating the fact of sending the warning information to the user terminal device 12. In particular, the communication portion 32 of the user-side server device 21 sends the warning notification information to the provider-side server device 22. Subsequently, the communication portion 52 of the provider-side server device 22 receives the warning notification information sent from the user-side server device 21, and then sends the received warning notification information to the provider-side terminal device 13. By virtue of this, because the communication service provider need not give notification of the fact of sending the reply to the work information to the information processing device 11 or the user terminal device 12, it is possible to reduce the operational burden on the communication service provider.

Next, an explanation will be made on the process of the information processing device 11 when the provider-side terminal device 13 sends the progress information indicating the work progress after the communication service provider starts providing the service. The communication portion 52 of the provider-side server device 22 receives either the progress information or completion information. The progress information is, for example, information indicating the progress of the line installation being carried out by the communication service provider for the user who has requested the provision of the service. The completion information is information indicating the completion of the line installation. The storage control portion 63 (the progress information storage means) of the provider-side server device 22 associates either the progress information or the completion information received by the communication portion 52 with the request ID, and lets the progress management database 26 store the same. Subsequently, the communication portion 52 sends, to the user-side server device 21, the request ID, and a progress information reception notification indicating the reception of the progress information (or a completion information reception notification indicating the reception of the completion information).

The communication portion 32 of the user-side server device 21 receives the request ID and a progress information reception notification (or a completion information reception notification) sent from the provider-side server device 22. The acquirement portion 42 (the progress information acquirement means) of the user-side server device 21 acquires the progress information (or the completion information) from the progress management database 26 based on the request ID received by the communication portion 32. Then, the communication portion 32 of the user-side server device 21 sends the progress information or the completion information acquired by the acquirement portion 42 to the user terminal device 12. The communication portion 32 sends, for example, the progress management information to the user terminal device 12 by email. Further, when receiving a requisition for the progress information from the user terminal device 12, the user-side server device 21 may acquire the progress information (or the completion information) stored in the progress management database 26, and send the same to the user terminal device 12.

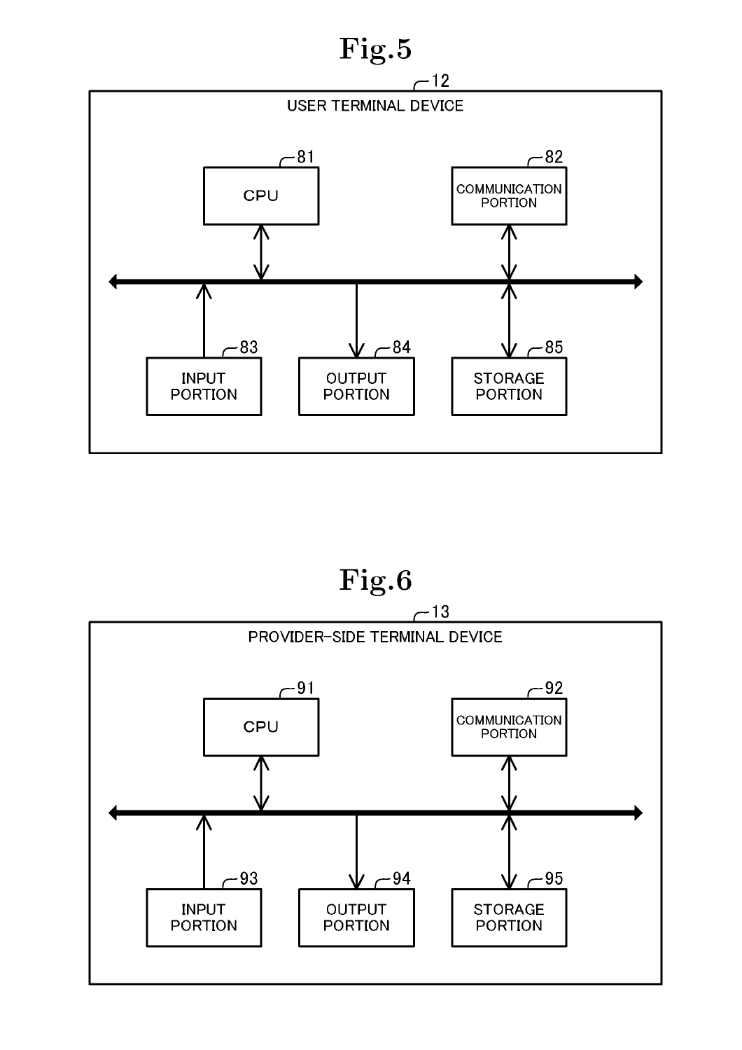

Next, referring to FIG. 5, a configuration of the user terminal device 12 will be explained. FIG. 5 is a block diagram showing the configuration of the user terminal device 12. As shown in FIG. 5, the user terminal device 12 includes a CPU 81, a communication portion 82, an input portion 83, an output portion 84, and a storage portion 85. The CPU 81 reads out programs to the RAM (not shown) to carry out various processes of the user terminal device 12.

The input portion 83 of the user terminal device 12 accepts the input of the user information and request information from the user. The communication portion 82 of the user terminal device 12 sends the inputted user information and request information to the user terminal device 12. Further, the communication portion 82 receives the request ID associated with the request information from the user-side server device 21. The storage portion 85 of the user terminal device 12 stores the request ID received by the communication portion 82. By storing the request ID, the user can inquire of the information processing device 11 about the progress of the provision of the service (the line installation and the like), etc.

Further, the communication portion 82 of the user terminal device 12 receives any of the progress management information, the progress information and the completion information sent from the user-side server device 21. Then, the output portion 84 of the user terminal device 12 outputs any of the progress management information, the progress information and the completion information received by the communication portion 82. If the output portion 84 outputs the progress management information, then the input portion 83 of the user terminal device 12 accepts the input of a reply (approval or alteration) to the work information included in the progress management information. The CPU 81 of the user terminal device 12 determines whether or not the reply to the work information the input of which is accepted by the input portion 83 is information indicating approval of the work information. If the CPU 81 determines that the reply to the work information is not information indicating the approval, then the input portion 83 accepts the input of alteration information indicating an alteration of the scheduled date for the installation and the like. Then, the communication portion 82 sends, to the user-side server device 21, the information indicating the approval or the alteration information as the answer information.

Further, after the communication service provider starts providing the service, the input portion 83 of the user terminal device 12 accepts the input of requisition information requesting for the progress of the service provision from the user. Then, the communication portion 82 of the user terminal device 12 sends the requisition information the input of which is accepted to the user-side server device 21, while receiving the progress information indicating the progress of the service provision from the user-side server device 21. The output portion 84 of the user terminal device 12 outputs the received progress information received by the communication portion 82.

Next, referring to FIG. 6, a configuration of the provider-side terminal device 13 will be explained. FIG. 6 is a block diagram showing the configuration of the provider-side terminal device 13. As shown in FIG. 6, the provider-side terminal device 13 includes a CPU 91, a communication portion 92, an input portion 93, an output portion 94, and a storage portion 95. The CPU 91 reads out programs to the RAM (not shown) to carry out various processes of the provider-side terminal device 13.

The communication portion 92 of the provider-side terminal device 13 receives the request ID and the order information sent from the provider-side server device 22. The output portion 94 of the provider-side terminal device 13 outputs the order information received by the communication portion 92. Then, the input portion 93 of the provider-side terminal device 13 accepts the input of work information from the communication service provider based on the order information outputted by the output portion 94. Subsequently, the communication portion 92 sends, to the provider-side server device 22, the request ID, and the work information the input of which is accepted by the input portion 93.

Further, the communication portion 92 of the provider-side terminal device 13 receives, from the provider-side server device 22, the answer information indicating the reply to the work information from the user. The output portion 94 of the provider-side terminal device 13 outputs the received answer information. By virtue of this, the communication service provider can confirm detailed information of the service such as the line installation and the like provided to the user.

Further, the input portion 93 of the provider-side terminal device 13 accepts the input of the request ID associated with a service, and the progress information (or the completion information) indicating the progress of that service at each stage of procession of the service (the line installation, for example) provided by the communication service provider. The communication portion 92 of the provider-side terminal device 13 sends, to the provider-side server device 22, the request ID and the progress information (or the completion information) inputted by the input portion 93.

[Operation]

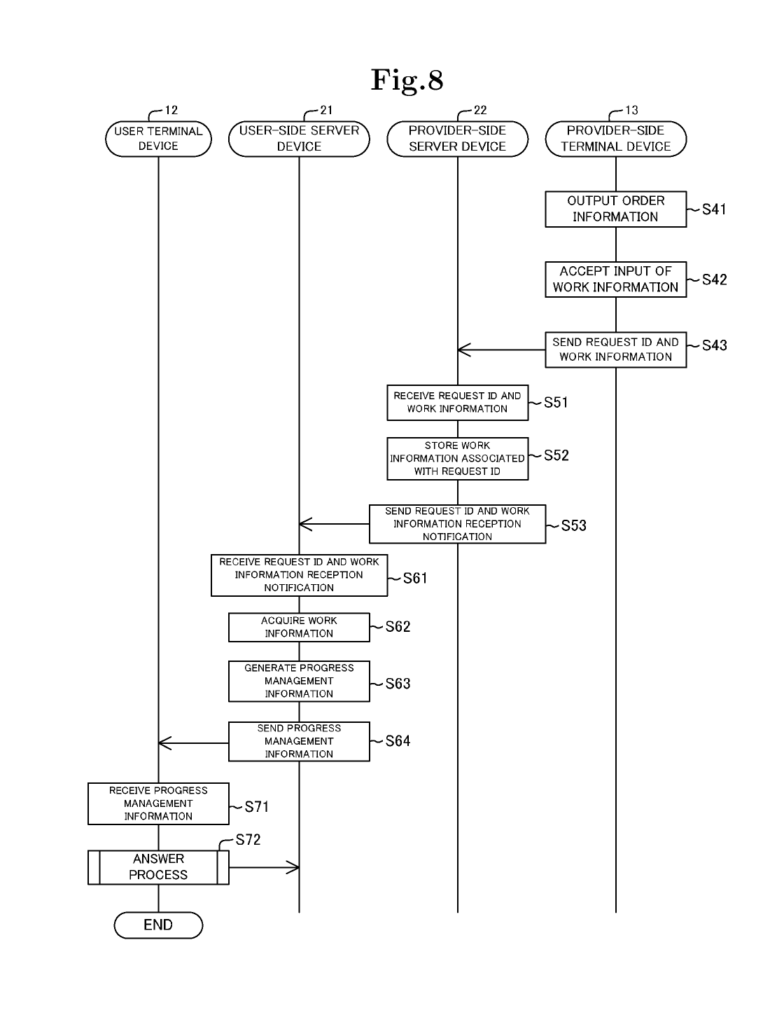

Next, referring to FIG. 7 through FIG. 14, the operation of the information processing system 1 described above will be explained in detail. To begin with, referring to FIG. 7 and FIG. 8, an explanation will be made on the operation when the user requests the communication service provider to arrange a (communication) line.

First, in the step S1 of FIG. 7, the input portion 83 of the user terminal device 12 accepts the input of the user information and the request information from the user. Subsequently, in the step S2, the communication portion 82 of the user terminal device 12 sends the user information and the request information the input of which is accepted through the process of the step S1, to the user-side server device 21 via the communication network 14.

Next, in the step S11, the communication portion 32 of the user-side server device 21 receives the user information and the request information sent from the user terminal device 12 through the process of the step S2. Subsequently, in the step S12, the generation portion 41 of the user-side server device 21 generates a request ID associated with the request information received through the process of the step S11. Then, in the step S13, the storage control portion 43 of the user-side server device 21 associates the request ID generated through the process of the step S12 with the request information, and lets the progress management database 26 store the both. Subsequently, in the step S14, the communication portion 32 of the user-side server device 21 sends the request ID generated through the process of the step S12, to the user terminal device 12 via the communication network 14.

Next, in the step S3, the communication portion 82 of the user terminal device 12 receives the request ID sent from the user-side server device 21 through the process of the step S14. Subsequently, in the step S4, the storage portion 85 of the user terminal device 12 stores the request ID received through the process of the step S3. The user can use the stored request ID to confirm the progress of the service associated with the request ID, etc.

On the other hand, in the step S15, the communication portion 32 of the user-side server device 21 sends, to the provider-side server device 22, the request ID generated through the process of the step S12, and the request information reception notification. Then, in the step S21, the communication portion 52 of the provider-side server device 22 receives the request ID and the request information reception notification sent from the user-side server device 21 through the process of the step S15. Subsequently, in the step S22, the acquirement portion 62 of the provider-side server device 22 acquires the request information associated with the request ID from the progress management database 26, based on the request ID received through the process of the step S21.

Next, in the step S23, the generation portion 61 of the provider-side server device 22 generates order information based on the request information acquired through the process of the step S22, and the items of the order sheet stored in the order sheet master 25. Then, in the step S24, the communication portion 52 of the provider-side server device 22 associates the request ID received through the process of the step S21 with the order information generated through the process of the step S23, and sends the both to the provider-side terminal device 13 via the communication network 14.

Subsequently, in the step S31, the communication portion 92 of the provider-side terminal device 13 receives the request ID and the order information sent through the process of the step S24. Subsequently, in the step S41 of FIG. 8, the output portion 94 of the provider-side terminal device 13 outputs the order information received through the process of the step S31 of FIG. 7. By virtue of this, the communication service provider confirms the request for the service (the line installation, for example) from the user (the customer).

Next, in the step S42, the input portion 93 of the provider-side terminal device 13 accepts the input of the work information (for example, the scheduled date and time for the work, and the like) from the communication service provider, based on the order information outputted through the process of the step S41. Subsequently, in the step S43, the communication portion 92 of the provider-side terminal device 13 sends, to the provider-side server device 22, the request ID, and the work information the input of which is accepted through the process of the step S42.

Then, in the step S51, the communication portion 52 of the provider-side server device 22 receives the request ID and the work information sent from the provider-side terminal device 13 through the process of the step S43. Subsequently, in the step S52, the storage control portion 63 of the provider-side server device 22 associates the work information with the request ID received through the process of the step S51, and then lets the progress management database 26 store the same.

Subsequently, in the step S53, the communication portion 52 of the provider-side server device 22 sends the request ID and the work information reception notification to the user-side server device 21. Then, in the step S61, the communication portion 32 of the user-side server device 21 receives the request ID and the work information reception notification sent from the provider-side server device 22 through the process of the step S53. Then, in the step S62, the acquirement portion 42 of the user-side server device 21 acquires the work information from the progress management database 26 based on the request ID received through the process of the step S61.

Next, in the step S63, the generation portion 41 of the user-side server device 21 generates progress management information describing the work information according to each line, based on the work information acquired through the process of the step S62. In the step S64, the communication portion 32 of the user-side server device 21 sends the progress management information to the user terminal device 12 via the communication network 14.

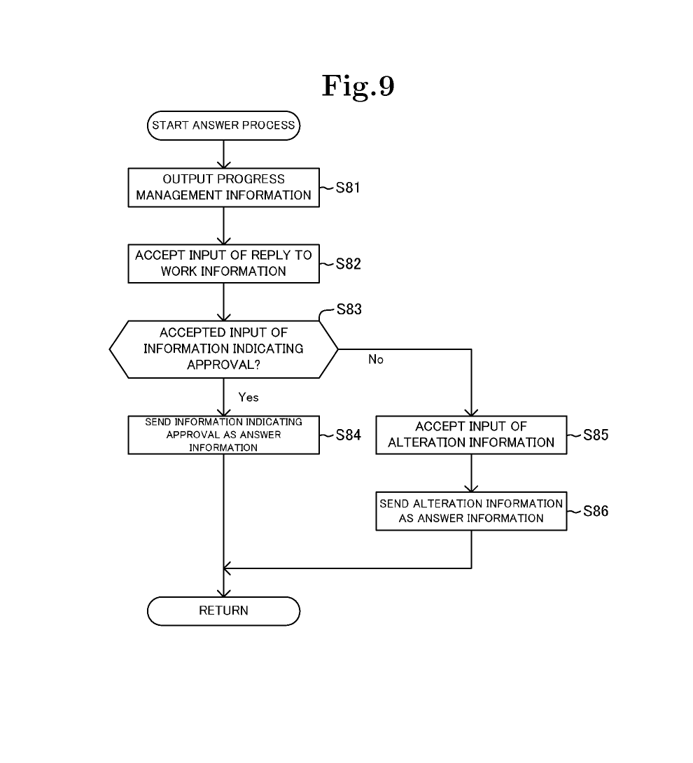

Subsequently, in the step S71, the communication portion 82 of the user terminal device 12 receives the progress management information sent through the process of the step S64. Then, in the step S72, the user terminal device 12 carries out an answer process. Referring to FIG. 9, the answer process will be explained.

FIG. 9 is a flowchart for explaining the answer process by the user terminal device 12. First, in the step S81, the output portion 84 outputs the progress management information received through the process of the step S71 of FIG. 8. By virtue of this, for example, the scheduled date and time for the line installation and the worker information (that is, the work information) are outputted according to each line. Subsequently, in the step S82, the input portion 83 accepts the input of a reply to the work information included in the progress management information. Subsequently, in the step S83, the CPU 81 determines whether or not the input of the information indicating approval is accepted as the reply to the work information. In the step S83, if the CPU 81 determines that the input of the information indicating approval is accepted (step S83: Yes), then in the step S84, the communication portion 82 sends, to the user-side server device 21, the information indicating approval as the answer information.

On the other hand, in the step S83, if the CPU 81 determines that the input of the information indicating approval is not accepted (step S83: No), for example, when the user alters the scheduled date and the like for the line installation, then in the step S85, the input portion 83 accepts the input of the alteration information indicating alteration of the work information. Then, in the step S86, the communication portion 82 sends, to the user-side server device 21, the alteration information the input of which is accepted through the process of the step S85 as the answer information. After the processes of the steps S84 and S86, the user terminal device 12 is finished with the answer process.

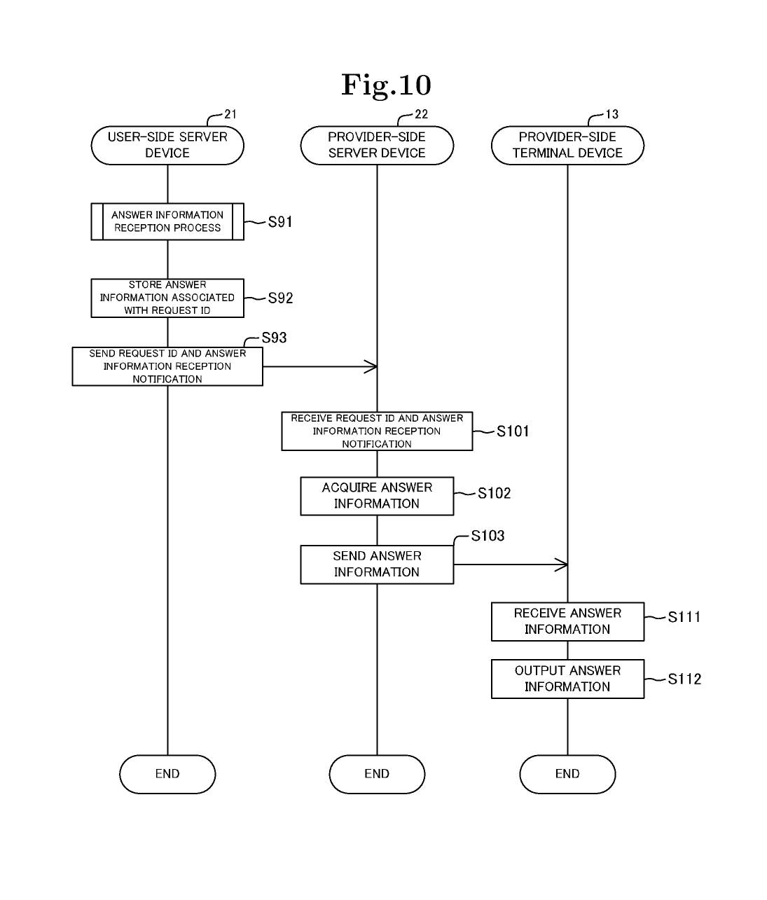

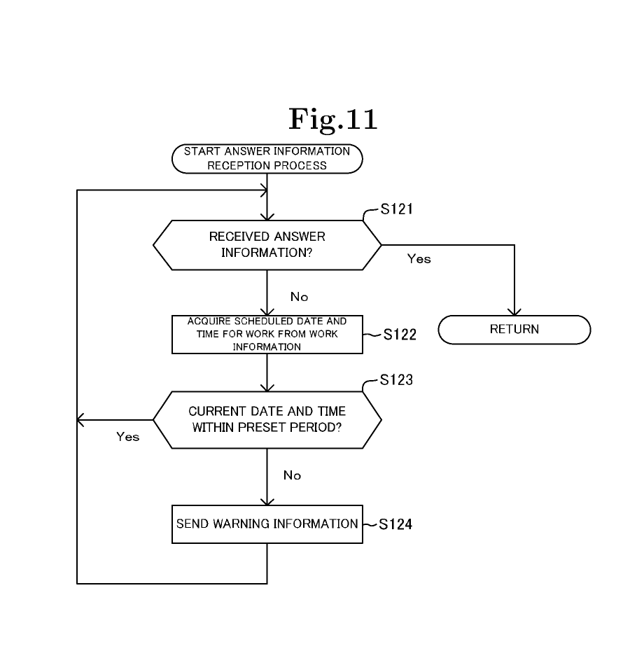

On the other hand, after the process of the step S64 of FIG. 8, in the step S91 of FIG. 10, the user-side server device 21 carries out an answer information reception process. Referring to FIG. 11, a warning process by the user-side server device 21 will be explained.

FIG. 11 is a flowchart for explaining the warning process by the user-side server device 21. First, in the step S121, the determination portion 44 determines whether or not the communication portion 32 has received the answer information from the user terminal device 12. In the step S121, if it is determined that the answer information has not yet been received (step S121: No), then in the step S122, the acquirement portion 42 acquires the scheduled date and time for the work from the work information.

Then, in the step S123, the determination portion 44 determines whether or not the current date and time is within a preset period. The preset period is, for example, from a preset date earlier than the scheduled date and time for the work, to the scheduled date and time for the work. That is, the determination portion 44 determines whether or not the current date and time is within the preset period earlier than the scheduled date and time for the work. In the step S123, if it is determined that the current date and time is within the preset period (step S123: Yes), then the process returns to the step S121, and the following processes are repeated.

On the other hand, in the step S123, if it is determined that the current date and time is not within the preset period (step S123: No), then in the step S124, the communication portion 32 sends, to the user terminal device 12, the warning information indicating the need for sending the answer information. After the process of the step S124, the process returns to the step S121, and the following processes are repeated.

On the other hand, in the step S121, if it is determined that the answer information is received (step S121: Yes), then the answer information reception process is ended, and the process proceeds to the step S92 of FIG. 10. By virtue of this, even if the user forgets to reply to the work information, it is still possible to notify and urge the user to reply to the work information by sending the warning information.

Further, the user-side server device 21 may set a plurality of different periods to send the warning information a plurality of times according to the set periods. Further, the user-side server device 21 may set a plurality of different pieces of warning information to send the warning information easier for the user to recognize as the current date and time approach the scheduled date for the work. For example, as the current date and time approach the scheduled date for the work, the warning information may be sent by sending emails as the warning information or displaying it in a larger size on the display screen of the output portion 84 of the user terminal device 12. Further, the user-side server device 21 may either constantly carry out the answer information reception process or periodically carry out the answer information reception process.

Next, in the step S92 of FIG. 10, the storage control portion 43 of the user-side server device 21 associates the answer information sent from the user terminal device 12 with the request ID, and lets the progress management database 26 store the same. Then, in the step S93, the communication portion 32 of the user-side server device 21 sends the request ID and the answer information reception notification to the provider-side server device 22.

Next, in the step S101, the communication portion 52 of the provider-side server device 22 receives the request ID and the answer information reception notification sent through the process of the step S93. Subsequently, in the step S102, the acquirement portion 62 of the provider-side server device 22 acquires the answer information from the progress management database 26 based on the request ID received through the process of the step S101. Then, in the step S103, the communication portion 52 of the provider-side server device 22 sends the answer information acquired through the process of the step S102 to the provider-side terminal device 13.

Subsequently, in the step S111, the communication portion 92 of the provider-side terminal device 13 receives the answer information. Then, in the step S112, the output portion 94 of the provider-side terminal device 13 outputs the answer information received through the process of the step S111. If the answer information outputted by the output portion 94 is the information indicating approval, then the communication service provider starts to provide the service (the line installation). On the other hand, if the answer information is the alteration information, then the input portion 93 accepts the input of new work information based on the alteration information from the communication service provider. Then, the same processes are carried out as those from the step S43 of FIG. 8. By virtue of this, the user can promptly and efficiently request for a service such as the line installation and the like, thereby allowing the improvement of convenience for users.

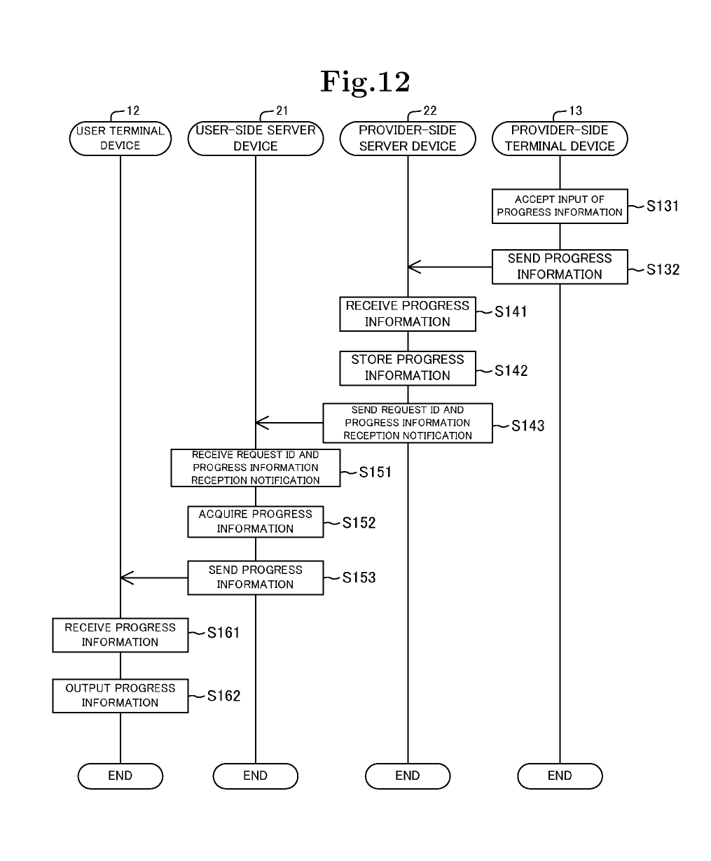

Next, referring to FIG. 12, an explanation will be made on the process in the case of managing the progress of a service (the line installation, for example). First, in the step S131, the input portion 93 of the provider-side terminal device 13 accepts the input of the progress information indicating the progress of the service. Subsequently, in the step S132, the communication portion 92 of the provider-side terminal device 13 sends the progress information inputted through the process of the step S131 to the provider-side server device 22.

Subsequently, in the step S141, the communication portion 52 of the provider-side server device 22 receives the progress information sent through the process of the step S132. Then, in the step S142, the storage control portion 63 of the provider-side server device 22 associates the progress information received through the process of the step S141 with the request ID, and lets the progress management database 26 store the same. Then, in the step S143, the communication portion 52 of the provider-side server device 22 sends the request ID and the progress information reception notification to the user-side server device 21.

Then, in the step S151, the communication portion 32 of the user-side server device 21 receives the request ID and the progress information reception notification sent through the process of the step S143. Subsequently, in the step S152, the acquirement portion 42 of the user-side server device 21 acquires the progress information from the progress management database 26 based on the request ID received through the process of the step S151. Then, in the step S153, the communication portion 32 of the user-side server device 21 sends the progress information acquired through the process of the step S152 to the user terminal device 12.

Subsequently, in the step S161, the communication portion 82 of the user terminal device 12 receives the progress information sent through the process of the step S153. Then, in the step S162, the output portion 84 of the user terminal device 12 outputs the progress information received through the process of the step S161. By virtue of this, when the progress is altered due to the provider, because the user is notified of that information, the user can easily grasp the progress of the service, thereby allowing the improvement of convenience for the user.

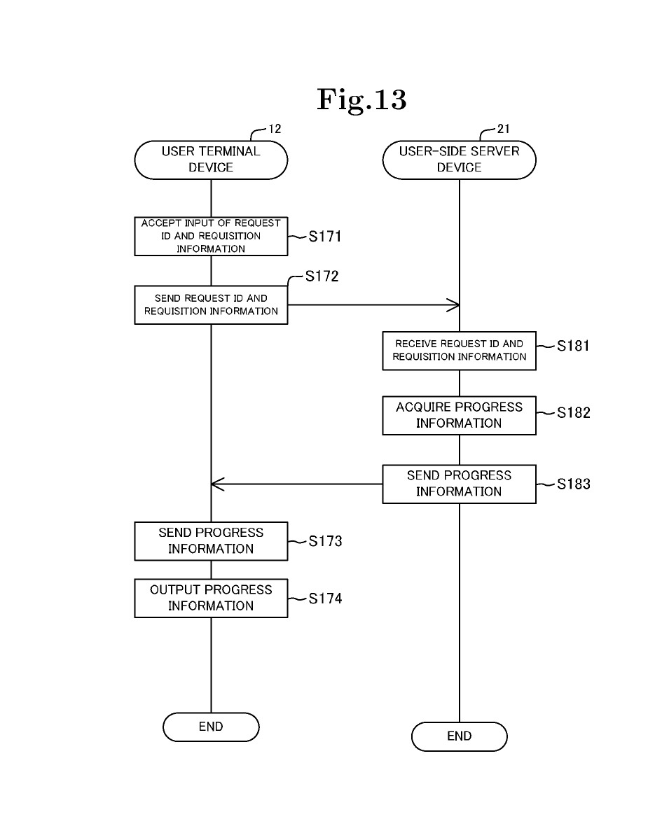

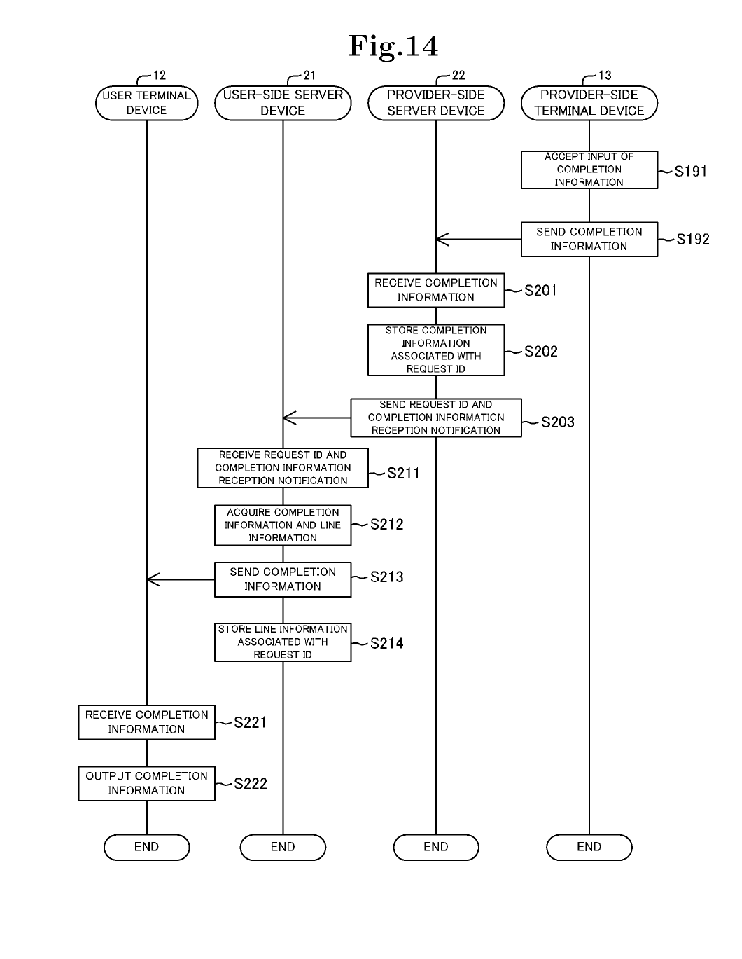

Further, the user terminal device 12 can also request for the progress information to output the same to the user. Referring to FIG. 13, an explanation will be made on the case for the user terminal device 12 to request for the progress information.

First, in the step S171, the input portion 83 of the user terminal device 12 accepts the input, from the user, of the request ID, and requisition information requesting for the progress information. Subsequently, in the step S172, the communication portion 82 of the user terminal device 12 sends the request ID and the requisition information to the user-side server device 21.

Then, in the step S181, the communication portion 32 of the user-side server device 21 receives the request ID and the requisition information sent through the process of the step S172. Next, in the step S182, the acquirement portion 42 of the user-side server device 21 acquires the progress information from the progress management database 26 based on the request ID. Subsequently, in the step S183, the communication portion 32 of the user-side server device 21 sends the progress information acquired through the process of the step S182 to the user terminal device 12.

Then, in the step S173, the communication portion 82 of the user terminal device 12 receives the progress information sent through the process of the step S183. Subsequently, in the step S174, the output portion 84 of the user terminal device 12 outputs the progress information received through the process of the step S173. By virtue of this, the user can promptly and easily conform the progress of the service, thereby allowing the improvement of convenience for the user.

Further, the user terminal device 12 can send not only the requisition information but also content alteration information for altering the contents of the service (altering the scheduled date for the installation, for example). In this case, the user-side server device 21 associates the content alteration information with the request ID and stores the same, while sending, to the provider-side server device 22, a message (a content alteration information reception notification) stating the reception of the content alteration information. Then, the provider-side server device 22 can acquire the content alteration information based on the request ID, and send the content alteration information to the provider-side terminal device 13.

Further, when the provision of a service (the line installation, for example) is completed, the provider-side terminal device 13 sends the completion information as the progress information. Referring to FIG. 14, an explanation will be made on the process when the provision of the service is completed.

First, in the step S191, the input portion 93 of the provider-side terminal device 13 accepts the input of the completion information indicating the completion of the service provision associated with the request ID. The completion information includes, for example, information of the date of completing the installation. Subsequently, in the step S192, the communication portion 92 of the provider-side terminal device 13 sends, to the provider-side server device 22, the completion information inputted through the process of the step S191. Subsequently, in the step S201, the communication portion 52 of the provider-side server device 22 receives the completion information sent through the process of the step S192. Then, in the step S202, the storage control portion 63 of the provider-side server device 22 associates the completion information received through the process of the step S201 with the request ID, and then lets the progress management database 26 store the same. Subsequently, in the step S203, the communication portion 52 of the provider-side server device 22 sends the request ID and the completion information reception notification to the user-side server device 21.

Then, in the step S211, the communication portion 32 of the user-side server device 21 receives the request ID and the completion information reception notification sent through the process of the step S203. Subsequently, in the step S212, the acquirement portion 42 of the user-side server device 21 acquires the completion information and the line information based on the request ID received through the process of the step S211. The acquired line information is information indicating the line for which the line installation is completed. Then, in the step S213, the communication portion 32 of the user-side server device 21 sends, to the user terminal device 12, the completion information acquired through the process of the step S212. Subsequently, in the step S214, the storage control portion 43 of the user-side server device 21 lets the line database 27 store the line information.

On the other hand, in the step S221, the communication portion 82 of the user terminal device 12 receives the completion information sent through the process of the step S213. Then, in the step S222, the output portion 84 of the user terminal device 12 outputs the completion information received through the process of the step S221. By virtue of this, because the user is notified that the provision of the service is completed, it is possible to promptly confirm that the user can use the service.

Further, when the user requests alteration or abolition of the line for which the installation (arrangement) is completed, by acquiring the line information from the line database 27 based on the request ID, it is possible to efficiently reuse the line. <Supplementary Notes>

The whole or part of the exemplary embodiment disclosed above can also be described as the following supplementary notes. Hereinbelow, an outline of the configurations of an information processing device and the like in accordance with the present invention will be explained. However, the present invention is not limited to following configurations.

(Supplementary Note 1)

An information processing device comprising:

a first communication means for receiving request information sent from a user terminal device operated by a user, to request for the user to use a service provided by a provider; and

a second communication means for sending, to a provider-side terminal device operated by the provider, order information generated based on the request information to place an order with the provider for providing the service to the user, and receiving, from the provider-side terminal device, work information indicating a schedule for the provider to provide the service to the user,

wherein the first communication means sends the work information to the user terminal device to receive answer information to the work information from the user terminal device and, according to the situation of receiving the answer information, sends warning information to the user terminal device to urge the sending of the answer information.

According to the supplementary note 1, the warning information is sent to the user terminal device to urge the sending of the answer information according to the situation of receiving the answer information. As a result, even if the user forgets to answer to the work information, with information processing device sanding the warning information, it is possible to suppress interruption of the information communications between the user terminal device and the provider-side terminal device.

(Supplementary Note 2)

The information processing device according to Supplementary Note 1, wherein if the answer information is not received from the user terminal device within a preset period, then the first communication means sends the warning information to the user terminal device.

According to the supplementary note 2, if the answer information is not received from the user terminal device within a preset period, then the warning information is sent to the user terminal device. Therefore, it is possible to more reliably suppress interruption of the information communications between the user terminal device and the provider-side terminal device, and continue the information communications between the user terminal device and the provider-side terminal device.

(Supplementary Note 3)

The information processing device according to Supplementary Note 2, wherein if the answer information is not received from the user terminal device within a preset period earlier than a scheduled date and time for a work included in the work information, then the first communication means sends the warning information to the user terminal device.

According to the supplementary note 3, if the answer information is not received within a preset period earlier than a scheduled date and time for a work, then the warning information is sent to the user terminal device. Therefore, the user is notified to send the answer information before the provider starts the work. As a result, it is possible for the provider to carry out the work as scheduled (to provide the service as scheduled).

(Supplementary Note 4)

The information processing device according to any one of Supplementary Notes 1 to 3, wherein if the first communication means has sent the warning information to the user terminal device, then the second communication means sends, to the provider-side terminal device, warning notification information indicating that the warning information has been sent to the user terminal device.

According to the supplementary note 4, because the warning notification information is sent to the provider-side terminal device, the provider need not notify the user to send the answer (reply) to the work information, thereby allowing reduction of operational burden on the provider.

(Supplementary Note 5)

The information processing device according to any one of Supplementary Notes 1 to 4, further comprising a first server device having the first communication means and a second server device having the second communication means, wherein the first server device further comprises an identification information generation means for generating identification information associated with the received request information, and a request information storage means for associating the request information with the generated identification information and letting a progress management database store the same; the first communication means sends the identification information to the second server device while the second communication means receives the identification information from the first server device; the second server device further comprises a request information acquirement means for acquiring the request information from the progress management database based on the received identification information; and the second communication means associates the received identification information with the order information generated based on the acquired request information, and sends the both to the provider-side terminal device.

According to the supplementary note 5, because the information processing device comprises the first server device and the second server device, it can process a large amount of information more efficiently. Further, because the identification information is sent and received between the first server device and the second server device, it is possible to reduce the amount of communication.

(Supplementary Note 6)

The information processing device according to Supplementary Note 5, wherein the second communication means receives, from the provider-side terminal device, progress information indicating progress of providing the service associated with the identification information, and the second server device further comprises a progress information storage means for associating the progress information with the identification information and letting the progress management database store the same.

According to the supplementary note 6, because of receiving the progress information sent from the provider-side terminal device and storing the received progress information in the progress management database, the mediator having the information processing device can constantly grasp the progress of the service.

(Supplementary Note 7)

The information processing device according to Supplementary Note 6, wherein the second communication means sends the identification information to the first server device while the first communication means receives the identification information from the second server device; the first server device further comprises a progress information acquirement means for acquiring the progress information from the progress management database based on the received identification information; and the first communication means sends the acquired progress information to the user terminal device.

According to the supplementary note 7, because the progress information is sent to the user terminal device, it is possible to easily confirm the progress of a service desired by the user.

(Supplementary Note 8)

The information processing device according to Supplementary Note 7, wherein the first communication means receives the identification information sent from the user terminal device, and requisition information indicating requisition for the progress information, and the progress information acquirement means acquires, from the progress management database, the progress information associated with the received identification information, according to the received requisition information.

According to the supplementary note 7, the progress of a service desired by the user is sent to the user terminal device according to the requisition information sent from the user terminal device. Therefore, when the user desires to confirm the progress of the desired service, he or she can reliably confirm the progress.

(Supplementary Note 9)

An information processing method comprising:

receiving request information sent from a user terminal device operated by a user, to request for the user to use a service provided by a provider;

sending, to a provider-side terminal device operated by the provider, order information generated based on the request information to place an order with the provider for providing the service to the user, and receiving, from the provider-side terminal device, work information indicating a schedule for the provider to provide the service to the user; and

sending the work information to the user terminal device to receive answer information to the work information from the user terminal device and, according to the situation of receiving the answer information, sending warning information to the user terminal device to urge the sending of the answer information.

(Supplementary Note 10)

A computer program comprising instructions for causing an information processing device to realize a function,

the information processing device comprising:

a first communication means for receiving request information sent from a user terminal device operated by a user, to request for the user to use a service provided by a provider; and

a second communication means for sending, to a provider-side terminal device operated by the provider, order information generated based on the request information to place an order with the provider for providing the service to the user, and receiving, from the provider-side terminal device, work information indicating a schedule for the provider to provide the service to the user,

wherein the first communication means sends the work information to the user terminal device to receive answer information to the work information from the user terminal device and, according to the situation of receiving the answer information, sends warning information to the user terminal device to urge the sending of the answer information.

Further, the computer program described in each of the above exemplary embodiment and supplementary notes is stored in a storage device and/or recorded in a computer-readable recording medium. The recording medium is, for example, a portable medium such as a flexible disk, optical disk, magnetic optical disk, semiconductor memory, or the like.

Hereinabove, the present invention is explained in reference to each exemplary embodiment described above. However, the present invention is not limited to the above exemplary embodiment. It is possible to apply various changes which can be understood by those skilled in the art to the configuration and/or details of the present invention within the scope of the present invention.

Further, the present application claims priority from Japanese Patent Application No. 2012-079715 filed on Mar. 30, 2012 in Japan, the disclosure of which is incorporated herein by reference in its entirety.

### REFERENCE SIGNS LIST

11 Information processing device
12 User terminal device
13 Provider-side terminal device
14 Communication network
21 User-side server device
22 Provider-side server device
23 Customer master
24 Line service master
25 Order sheet master
26 Progress management database
27 Line database
32 Communication portion
41 Generation portion
42 Acquirement portion
43 Storage control portion
44 Determination portion
52 Communication portion
61 Generation portion
62 Acquirement portion
63 Storage control portion
81 CPU
82 Communication portion
83 Input portion
84 Output portion
85 Storage portion
91 CPU
92 Communication portion
93 Input portion
94 Output portion
95 Storage portion

1. An information processing device comprising:
a first communication unit for receiving request information sent from a user terminal device operated by a user, to request for the user to use a service provided by a provider; and
a second communication unit for sending, to a provider-side terminal device operated by the provider, order information generated based on the request information to place an order with the provider for providing the service to the user, and receiving, from the provider-side terminal device, work information indicating a schedule for the provider to provide the service to the user,
wherein the first communication unit sends the work information to the user terminal device to receive answer information to the work information from the user terminal device and, according to the situation of receiving the answer information, sends warning information to the user terminal device to urge the sending of the answer information.

2. The information processing device according to claim 1, wherein if the answer information is not received from the user terminal device within a preset period, then the first communication unit sends the warning information to the user terminal device.

3. The information processing device according to claim 2, wherein if the answer information is not received from the user terminal device within a preset period earlier than a scheduled date and time for a work included in the work information, then the first communication unit sends the warning information to the user terminal device.

4. The information processing device according to claim 1, wherein if the first communication unit has sent the warning information to the user terminal device, then the second communication unit sends, to the provider-side terminal device, warning notification information indicating that the warning information has been sent to the user terminal device.

5. The information processing device according to claim 1, further comprising a first server device having the first communication unit means and a second server device having the second communication unit, wherein the first server device further comprises an identification information generation unit for generating identification information associated with the received request information, and a request information storage unit for associating the request information with the generated identification information and letting a progress management database store the same; the first communication unit sends the identification information to the second server device while the second communication unit receives the identification information from the first server device; the second server device further comprises a request information acquirement unit for acquiring the request information from the progress management database based on the received identification information; and the second communication unit associates the received identification information with the order information generated based on the acquired request information, and sends the both to the provider-side terminal device.

6. The information processing device according to claim 5, wherein the second communication unit receives, from the provider-side terminal device, progress information indicating progress of providing the service associated with the identification information, and the second server device further comprises a progress information storage unit for associating the progress information with the identification information and letting the progress management database store the same.

7. The information processing device according to claim 6, wherein the second communication unit sends the identification information to the first server device while the first communication unit receives the identification information from the second server device; the first server device further comprises a progress information acquirement unit for acquiring the progress information from the progress management database based on the received identification information; and the first communication unit sends the acquired progress information to the user terminal device.

8. The information processing device according to claim 7, wherein the first communication unit receives the identification information sent from the user terminal device, and requisition information indicating requisition for the progress information, and the progress information acquirement unit acquires, from the progress management database, the progress information associated with the received identification information, according to the received requisition information.

9. An information processing method comprising:
receiving request information sent from a user terminal device operated by a user, to request for the user to use a service provided by a provider;
sending, to a provider-side terminal device operated by the provider, order information generated based on the request information to place an order with the provider for providing the service to the user, and receiving, from the provider-side terminal device, work information indicating a schedule for the provider to provide the service to the user; and
sending the work information to the user terminal device to receive answer information to the work information from the user terminal device and, according to the situation of receiving the answer information, sending warning information to the user terminal device to urge the sending of the answer information.

10. A non-transitory computer-readable storage medium storing a computer program comprising instructions for causing an information processing device to realize a function,
the information processing device comprising:
a first communication unit for receiving request information sent from a user terminal device operated by a user, to request for the user to use a service provided by a provider; and
a second communication unit for sending, to a provider-side terminal device operated by the provider, order information generated based on the request information to place an order with the provider for providing the service to the user, and receiving, from the provider-side terminal device, work information indicating a schedule for the provider to provide the service to the user,
wherein the first communication unit sends the work information to the user terminal device to receive answer information to the work information from the user terminal device and, according to the situation of receiving the answer information, sends warning information to the user terminal device to urge the sending of the answer information.
